(19) United States
(12) Patent Application Publication
(10) Pub. No.: US 2013/0314836 A1
(43) Pub. Date: Nov. 28, 2013

(54) Transistor Overcurrent Detection

(71) Applicant: Robert Douglas Christie, Dalgety Bay (GB)

(72) Inventor: Robert Douglas Christie, Dalgety Bay (GB)

(73) Assignee: ALLEGRO MICROSYSTEMS, INC., Worcester, MA (US)

(21) Appl. No.: 13/479,804

(22) Filed: May 24, 2012

(51) Int. Cl. H02H 3/093

(52) U.S. Cl. 361/95

(57) ABSTRACT

Circuits and methods for overcurrent fault detection using a debounce timer to qualify the presence of an overcurrent fault based on an overcurrent signal being asserted for at least a predetermined time interval. The debounce timer may be used in conjunction with state-qualified fault sensing and/or blank-time-qualified fault sensing.

### BACKGROUND

Integrated circuits and hardware/software combination devices are well known in the art of electronics for their ability to combine the functions of a number of discrete circuits into one package. One particular group of such devices is concerned with control devices or drivers for MOSFET (metal oxide semiconductor field effect transistor) and similar power-conducting or power-controlling devices. Of particular interest in such devices are techniques and circuits for sensing overcurrent faults in the driven transistor or device.

One circuit 100 for determining an overcurrent condition in a MOSFET or other driven device is shown in FIG. 1. A conventional device driver 101 controls a driven device 105, which is shown here as a MOSFET. The voltage V_{DS} 110 is measured between the drain and the source of MOSFET 105. If V_{DS} exceeds a predetermined threshold V_{DSTH} 120, an overcurrent fault is indicated by signal OC at the output of comparator 130. In such a scenario, an overcurrent fault is deemed present in MOSFET 105. The fault is ignored, however, when the MOSFET 105 is in the off or non-conducting state (i.e., when a CMD signal is not asserted, CMD=low), because of state qualifier element 150. In state qualifier element 150, the OC and CMD signals are coupled to the inputs of AND gate 152, the output of which provides a state-qualified overcurrent fault signal OCF that is asserted only if both the CMD signal is high indicating that the MOSFET 105 is conducting and the OC signal is high indicating an overcurrent fault in the MOSFET 105. State qualifier element 150 thus provides a measure of protection against spurious OC signals caused by switching transients or other noise signals that may be present at the MOSFET, since only actual overcurrent conditions present when the MOSFET 105 is conducting will produce in a positive OCF signal.

However, when the MOSFET 105 switches from the off state to the on state, it will take some time before it is fully conducting, resulting in false indications of an overcurrent condition by the OC signal as the voltage across MOSFET 105 fluctuates. (The time it takes for the MOSFET to become fully conducting is a function of the gate drive circuit and the total charge required to be transferred to the gate of the MOSFET. The on resistance reduces as the charge transferred to the gate increases. Until the on resistance has reached its normal operating level the gate source voltage may indicate an overcurrent condition.) Using the circuit 100 of FIG. 1, the overcurrent fault signal OCF will likely be inaccurate during that time because the CMD signal will be asserted while the OC signal is still settling.

To overcome this false overcurrent fault problem, an alternate scheme for overcurrent detection ignores the OC signal (i.e., the output of the voltage comparator 130 in FIG. 1) for a period of time, usually referred to as the blank time, following the assertion of the CMD signal. A functional diagram of such a circuit 200 is illustrated in FIG. 2. A blank timer 210 is responsive to the CMD signal such that an output signal, BLANKN, of the timer is held low for while the CMD signal is low and for a predetermined blank time duration after the CMD signal is asserted (i.e., after MOSFET 105 has begun conducting), following which the BLANKN signal goes high. The output of the blank timer is used to qualify the overcurrent signal OC with an AND gate 220; blank timer 210 and AND gate 220 thus form a blank time qualifier element 250. The output of AND gate 220 forms a blank-time-qualified overcurrent fault signal OCF′. However, this method is successful when only a single MOSFET is switching in a system or when all MOSFETs in a circuit, for example in a power bridge circuit, switch at the same time.

When a number of MOSFETs in a common circuit or system, for example a multi-phase power bridge, switch at different times, then it is possible for a switching transient in one phase, or leg, of the power bridge to affect the voltage and currents in other phases. In this case, both the state-qualified and the blank-time-qualified methods may still indicate false overcurrent conditions.

### SUMMARY

Presently disclosed are improved circuits and methods of use therefore that overcome the false overcurrent fault indication limitations of existing fault detection devices. The concepts, systems, and techniques disclosed herein use a debounce timer to additionally qualify the presence of an overcurrent fault based on a detected overcurrent signal. These improved circuits and methods may be used in conjunction with state-qualified fault detection and may additionally be used in conjunction with, or as a replacement for, blank-time-qualified fault detection.

In one exemplary embodiment, a state-qualified overcurrent indication, OCF, is used to reset a debounce timer when OCF is not asserted. A fault must be present, indicated by the assertion of OCF, for longer than a predetermined debounce time before a true fault is indicated by the assertion of the output of the debounce timer, FAULT.

Selected to establish a predetermined debounce time, t_{DB}, representing a delay from the OCF signal low-to-high transition, the debounce timer continually resets in the presence of noise (“bounces”) on the OC signal and only sets (FAULT to high) once the OCF or OCF′ signal transitions to high and remains high for a predetermined debounce time t_{DB}.

Embodiments of the concepts, systems, and techniques disclosed herein may include a method of qualifying an overcurrent fault signal, comprising: furnishing a state qualifier element responsive to a state input and responsive to an overcurrent input generated by sensing an overcurrent condition, said state qualifier element having a qualifier output, said state qualifier element configured to assert said qualifier output when said state input and said overcurrent input are mutually asserted; furnishing a debounce timer having a debounce reset input and an overcurrent fault signal output; coupling the qualifier output to the debounce reset input; and causing said overcurrent fault signal to transition to indicate said overcurrent condition at a predetermined time after said debounce reset input transitions to an asserted state if the qualifier output remains asserted during said predetermined time.

Such a method may further include: furnishing a blank timer having a blanking reset input responsive to said state input and a blanking signal output operably coupled to said qualifier element; wherein said blank timer delays said blanking signal output for a second predetermined time after said state input transitions to an asserted state.

The method may further include: furnishing a comparator coupled to a driven device and providing the overcurrent input indicative of a voltage across the driven device exceeding a threshold voltage. Furthermore, the state input may be a signal indicative of a conduction state of a driven device.

Embodiments of the concepts, systems, and techniques disclosed herein may also include a circuit adapted to sense and signal an overcurrent fault, comprising: a state qualifier element responsive to a state input and responsive to an overcurrent input, and having a qualifier output, said state qualifier element configured to assert said qualifier output when said state input and said overcurrent input are mutually asserted; and a debounce timer having a debounce reset input and a overcurrent fault signal output, said debounce reset input operably coupled to said qualifier output, wherein said debounce timer causes said overcurrent fault signal to transition to indicate an overcurrent condition at a predetermined time after said debounce reset input transitions to an asserted state if the qualifier output remains asserted during said predetermined time.

Such a circuit may further include: a blank timer having a blanking reset input responsive to said state input and a blanking signal output operably coupled to said state qualifier element, wherein said blank timer delays said blanking signal output for a second predetermined time after said state input transitions to an asserted state.

The circuit may further include a comparator coupled to a driven device and providing the overcurrent input indicative of a voltage across the driven device exceeding a threshold voltage. Furthermore, the state input may be a signal indicative of a conduction state of a driven device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a functional block diagram of a prior art state-qualified overcurrent detection circuit.

FIG. 2 is a functional block diagram of a prior art blank-time-qualified overcurrent detection circuit.

FIG. 3 is a functional block diagram of a debounce-qualified overcurrent detection circuit, constructed according to one embodiment of the present invention.

FIG. 4 is a functional block diagram of a debounce-qualified overcurrent detection circuit with a blank time qualifier, constructed according to an alternate embodiment of the present invention.

FIG. 5 is a signal timing diagram illustrating overcurrent fault qualification in four representative fault detection circuits when no actual fault is present.

FIG. 6 is a signal timing diagram illustrating overcurrent fault qualification in four representative fault detection circuits when a permanent fault is present.

FIG. 7 is a signal timing diagram illustrating overcurrent fault qualification in four representative fault detection circuits when a transient fault occurs.

FIG. 8 is a signal timing diagram illustrating overcurrent fault qualification in four representative fault detection circuits when a permanent fault exhibiting a switching transient occurs.

FIGS. 9A and 9B are flowcharts of alternate methods of providing debounce-qualified overcurrent fault detection, according to several embodiments of the present invention.

### DETAILED DESCRIPTION

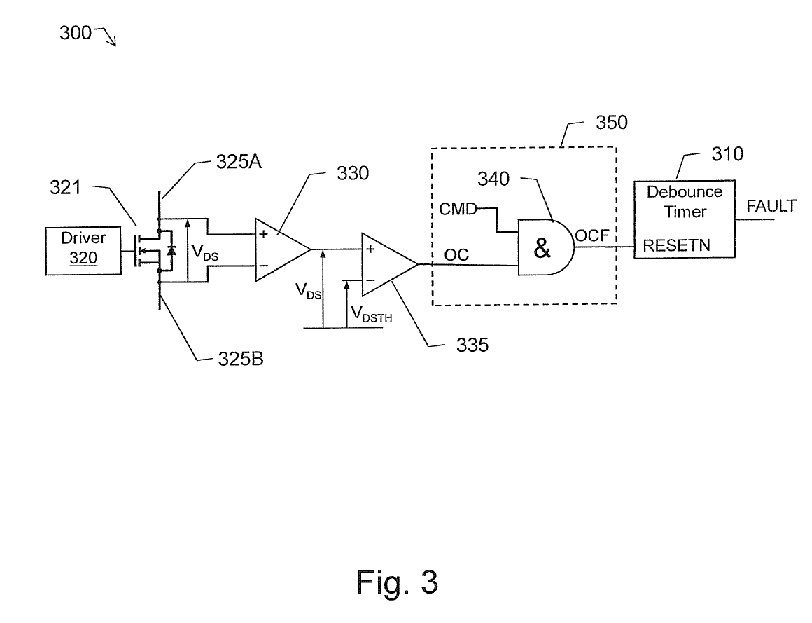

Embodiments of the present concepts, systems, and techniques are directed to circuits and methods of operation that overcome the known limitations of prior art overcurrent fault detection methods. In one circuit embodiment 300, shown in FIG. 3, a debounce timer 310 may be used to further qualify the presence of a fault condition as indicated by a state-qualified overcurrent fault signal OCF. In particular, the debounce timer generates an overcurrent fault signal FAULT at its output that indicates the presence of an overcurrent condition at a predetermined time after the overcurrent condition is indicated by a transition of the state-qualified overcurrent fault signal OCF, with the predetermined time being established by the debounce timer 310.

Circuit 300 may, in one exemplary embodiment, comprise a driver 320 for driving a transistor or other device 321 that, in the illustrative embodiment of FIG. 3, is shown without limitation to be a MOSFET. The MOSFET drain and source terminals 325A and 325B may be coupled to an operational amplifier (opamp, or similar device, without limitation) 330, the output of which is at a signal level V_{DS} indicative of the voltage across the MOSFET 321. In one illustrative embodiment, the opamp 330 is a differential to single-ended differential amplifier. However, it will be appreciated by those of ordinary skill in the art that various types of differential to single-ended opamps, including with positive gain, unity gain, or attenuation, may be used. The opamp output signal V_{DS} may be coupled to a comparator 335 (or similar device, without limitation, that may or may not include hysteresis) that compares the voltage V_{DS} to a threshold voltage V_{DSTH}. When the voltage V_{DS} exceeds the predetermined threshold V_{DSTH}, an overcurrent condition is indicated by a transition in the comparator output signal OC.

In order to avoid the problem of false OC signals, the OC signal is conditioned on (or “qualified” by) a command signal (CMD), representing the conduction state of MOSFET 321, in AND gate 340. (In general, CMD is a signal to the driver to command MOSFET 321 to enter the on or conducting state. It is typically provided by the controlling logic and may be based on multiple factors.) AND gate 340 may thus be referred to herein as state qualifier element 350; the CMD signal may thus be referred to herein as the state input.

When MOSFET 321 is commanded into a conducting state, the CMD signal is asserted (i.e., CMD is high). The CMD signal and the OC signal may be coupled to AND gate 340, which provides the state-qualified overcurrent fault signal OCF at its output. Thus, the OCF signal is asserted only if both the OC and CMD signals are asserted. The OCF signal may be coupled to an active low input, RESETN, of the debounce timer 310 as shown. Thus, when the OC signal is low (indicating that no overcurrent condition is present), the debounce timer 310 is reset. With this arrangement, once the OCF signal goes high (providing a state-qualified indication of a fault), the overcurrent fault signal FAULT will not go high to indicate the presence of an actual overcurrent fault unless the OCF signal remains high for longer than the predetermined debounce time interval t_{DB} established in debounce timer 310.

One of ordinary skill in the art will appreciate that, although circuit 300 and driven device 321 are described above in general terms, specific embodiments are contemplated. In particular, driven device 321 may be a MOSFET transistor. And, although a MOSFET driver 320 is described in connection with the several drawings provided herein, those skilled in the art will realize that driver circuits other than those designed for MOSFET transistors or transistor/power switching devices (in general) may be used with the concepts, systems, and techniques for overcurrent fault detection and qualification described herein. Accordingly, the concepts, systems, and techniques described herein are not limited to any particular type of driver or driven device circuit.

Furthermore, although a state-qualified element 350 responsive to a MOSFET conduction state signal CMD is described, those skilled in the art will realize that qualifier inputs other than the CMD signal can be used. For example, the state of the driven transistor 321 (or of an aspect of driver 320) could be detected indirectly and used to qualify overcurrent signal OC. Accordingly, the concepts, systems, and techniques described herein are not limited to any particular type of state-qualification.

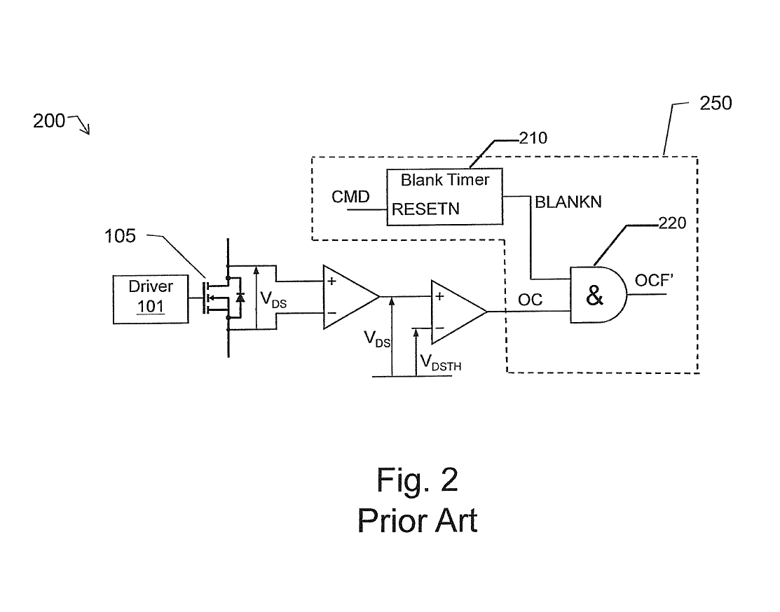

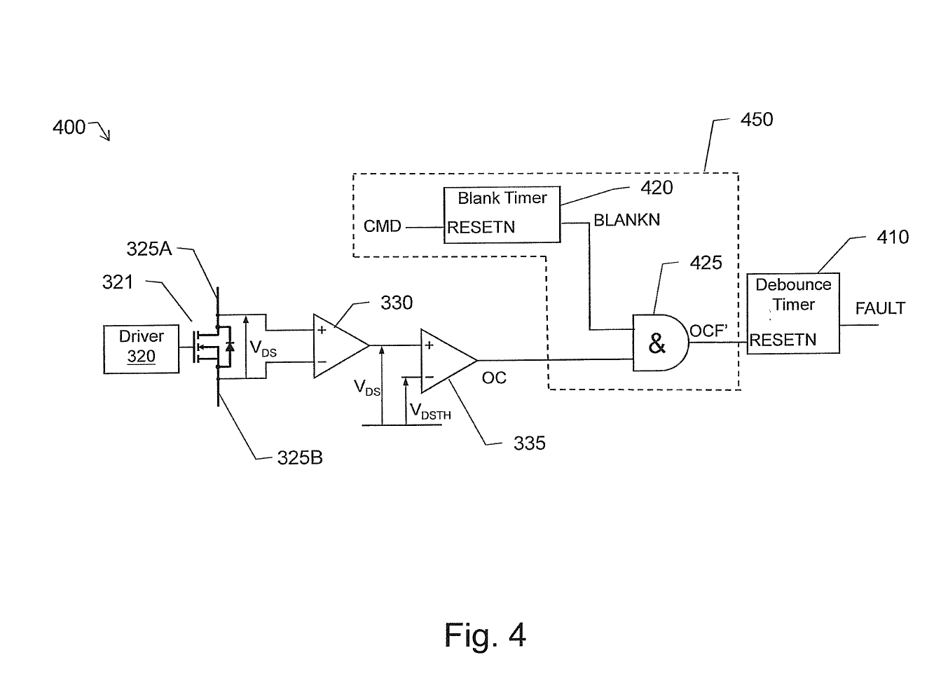

While the debounce timer 310 is used in conjunction with the state qualifier element 350 in the embodiment of FIG. 3, such a circuit and method of operation may also be used in conjunction with, or as a replacement for, the blank time qualifier element shown in FIG. 2. One such alternate embodiment is shown in FIG. 4, which illustrates a debounce-qualified overcurrent detection circuit with a blank time qualifier. Embodiments of the concepts, systems, and techniques that use both a blank time qualifier and a debounce qualifier together are desirable when the power switching element's switching time needs to be long, for example (but not by way of limitation), when a slow turn on time is used to mitigate electromagnetic radiation from the switching transients. This may be especially necessary when the transient effects are known to be of short duration and fast overcurrent condition detection is required.

Circuit 400 may comprise a driver 320 for driving a transistor or other device 321, as described above with respect to FIG. 3. As in FIG. 3, representative MOSFET drain and source terminals 325A and 325B may be coupled to an opamp 330, the output of which is at a signal level V_{DS} indicative of the voltage across the MOSFET 321. The opamp output signal V_{DS} may be coupled to a comparator 335 that compares the voltage V_{DS} to a threshold voltage V_{DSTH}. When the voltage V_{DS} exceeds the predetermined threshold V_{DSTH}, an overcurrent condition is indicated by a transition in the comparator 335 output signal OC, again as in FIG. 3 but without limitation.

Circuit 400, in one exemplary embodiment, uses state input signal CMD to trigger a blanking timer (also referred to herein as a blank timer) 420. When MOSFET 321 is commanded into a conducting state, the CMD signal is asserted, clearing a blanking reset input (blank timer input RESETN) and causing blank timer 420 to run for a predetermined time t_{BL}. On expiration of time t_{BL}, blank timer 420 asserts blanking signal output BLANKN, which may be coupled to AND gate 425. The output of the blank timer may thus be used to qualify overcurrent signal OC in AND gate 425. The output of AND gate 425 thus forms blank-time-qualified fault signal OCF′ (also referred to herein as the qualifier output) such that the OCF′ signal is asserted only if both the OC and BLANKN signals are asserted. AND gate 425 and blank timer 420 may be referred to herein as blank time qualifier element 450, which includes a state qualifier element (AND gate 425) and blank timer 420.

The OCF′ signal is coupled to an active low input, RESETN, of the debounce timer 410 as shown. Thus, when the blank-time-qualified signal OCF′ is low (indicating that no overcurrent condition is present), the debounce timer 410 is reset. With this arrangement, once the OCF′ signal goes high (providing the blank-time-qualified overcurrent fault indication), the overcurrent fault signal FAULT will not go high to indicate the presence of an actual overcurrent fault unless the OCF′ signal remains high for longer than the predetermined debounce time interval t_{DB} established in debounce timer 410.

The debounce-qualified overcurrent fault detection concepts, systems, and techniques described herein thus improve fault detection over prior art circuits and methods by avoiding false fault indications. To permit this fault qualification to take place, fault detection is delayed by a small amount of time. This predetermined debounce time interval t_{DB} is set dependent on the needs and performance parameters of the application, particular driver circuits, and the driven power devices. Typical ranges are 0.1 to 100 microseconds, but may range from picoseconds to tens of milliseconds.

As both overcurrent detection circuit 300 (FIG. 3) and overcurrent detection circuit 400 (FIG. 4) employ a debounce timer to qualify or condition their FAULT output signal, they may be generally referred to herein as debounce-qualified circuits. When a specific embodiment of a debounce-qualified circuit is to be referenced, the circuit designator 300 or 400 will also be used.

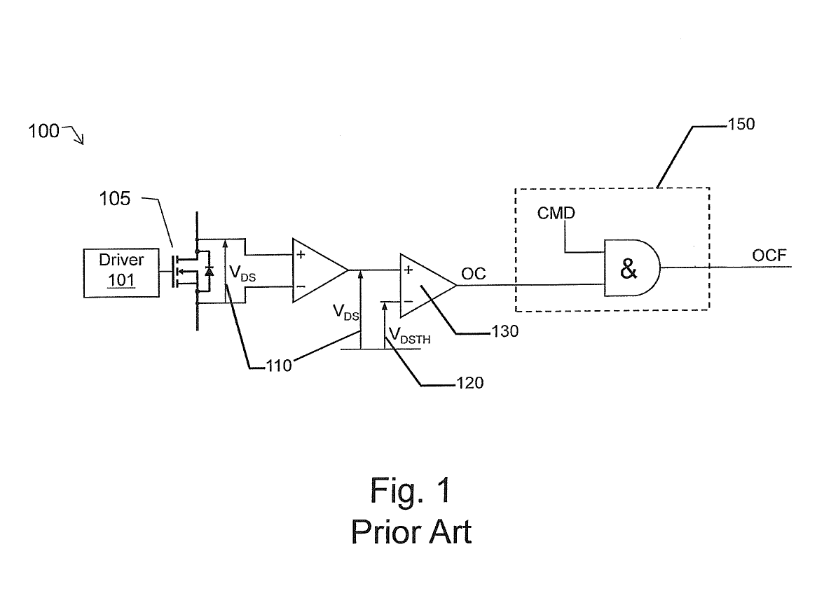

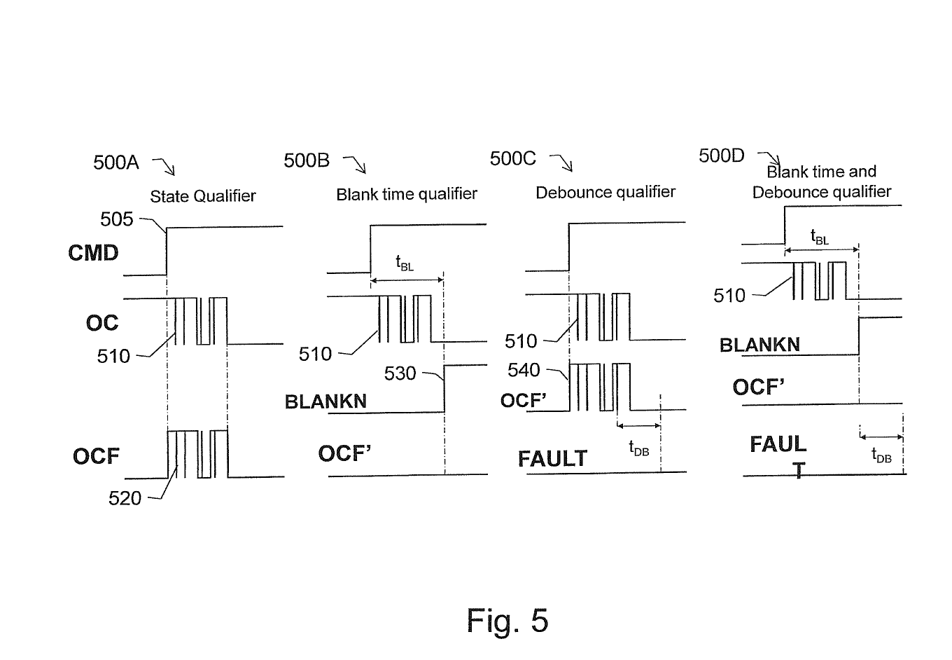

A timing and fault output comparison of the prior art state-qualified and blank-time-qualified fault detection methods with the present debounce-qualified circuits in different overcurrent scenarios are shown in each of FIGS. 5, 6, 7, and 8. In each Figure, timing diagram A shows the timing of fault detector output OCF in relation to the CMD and OC signals in the prior art state-qualified fault detector circuit 100 of FIG. 1. Timing diagram B shows the timing of fault detector output OCF′ in relation to the CMD and OC signals in the prior art blank-time-qualified fault detector circuit 200 of FIG. 2. Timing diagram C shows the timing of fault detector output FAULT in relation to the CMD and OC signals in the debounce-qualified circuit 300 of FIG. 3. The comparison of the three timing diagrams in each failure scenario, discussed below, illustrates how the debounce timer prevents the propagation of erroneous FAULT signals that the prior art cannot stop.

FIG. 5 shows the fault outcomes and corresponding output signals for a scenario where the driven device (e.g., without limitation, a MOSFET) is commanded to switch to a conducting state, i.e., when CMD signal goes high at 505. In a circuit 100 having only a simple state qualifier (depicted in timing diagram 500A), a false OCF signal 520 is generated during a switching transient represented by transients 510 on signal OC. However, either the blank-time-qualified circuit 200 (timing diagram 500B) or the debounce-qualified circuit 300 (timing diagram 500C) can ensure that no false fault is produced at the outputs OCF′ and FAULT, respectively, in the presence of OC signal transients 510. Additional circuitry, not shown, may be employed to latch or otherwise capture the occurrence (assertion) of the FAULT signal.

In a blank-time-qualified circuit 200, shown in timing diagram 500B, the time delay t_{BL} of the blanking timer (represented by the delay in the rising edge of BLANKN signal 530) prevents OC transients 510 from propagating to the OCF′ output.

In a debounce-qualified circuit 300, shown in timing diagram 500C, OC signal transients 510 result in matching transients on signal OCF′ as expected. However, the debounce timer 310 prevents these transients from propagating to the FAULT signal by requiring the OCF′ signal to be asserted for longer than the debounce interval t_{DB} before asserting the FAULT signal. Thus, when t_{DB} is properly chosen to be longer than the typical transient 510 duration, the debounce timer prevents spurious overcurrent fault indications.

In a circuit 400 having both a blank time qualifier and a debounce timer, shown in timing diagram 500D, the time delay t_{BL} of the blanking timer (represented by the delay in the rising edge of BLANKN signal 530) again prevents OC transients 510 from propagating to the FAULT signal output.

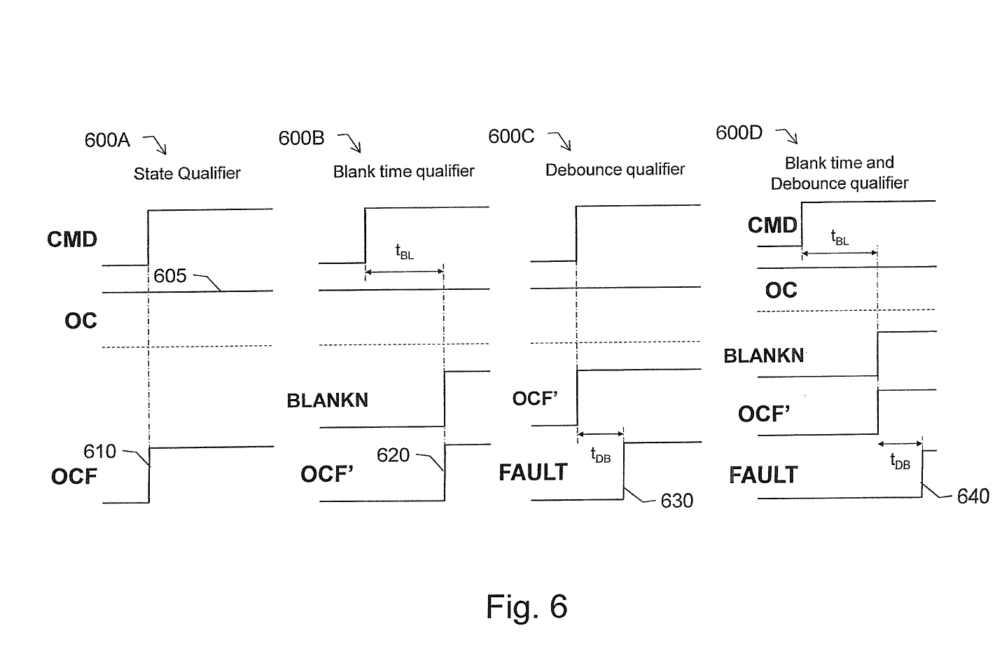

FIG. 6 shows the fault outcomes when a permanent fault, represented by signal OC set high 605, is present at the time the driven device is commanded to switch on. In a state-qualified circuit 100 (timing diagram 600A), OCF 610 appears as soon as CMD is asserted. In the blank-time-qualified circuit 200 (timing diagram 600B), OCF′ 620 appears one blank time t_{BL} after the driven transistor is commanded on, due to the delay of the blank timer. However, in the debounce-qualified circuit 300 (timing diagram 600C), FAULT 630 appears one debounce time t_{DB} after CMD is asserted. In the blank-time- and debounce-qualified circuit 400 (timing diagram 600D), FAULT 640 appears one blank time t_{BL} plus one debounce time t_{DB} after CMD is asserted due to the cascade of these two qualifiers.

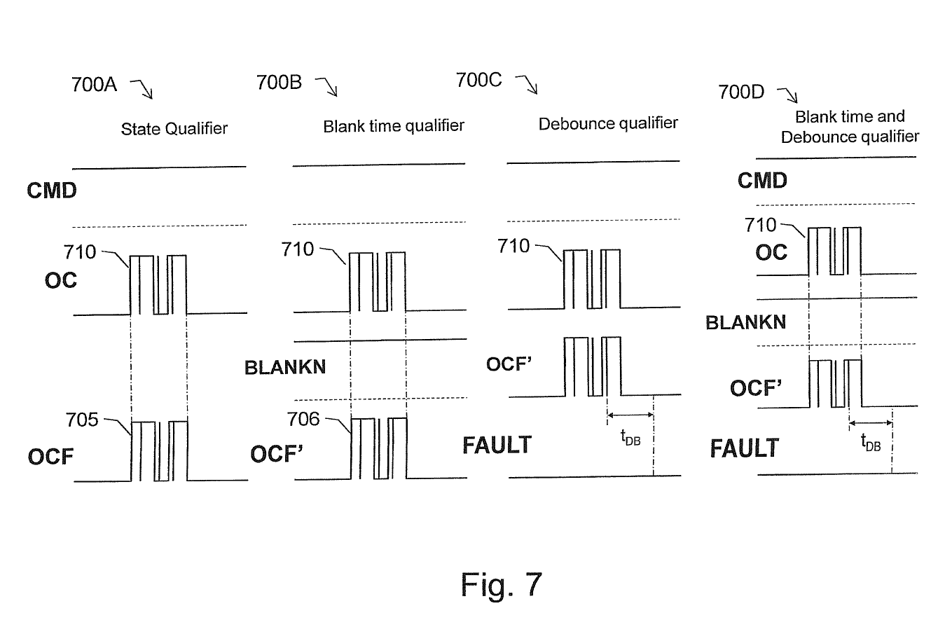

FIG. 7 shows the fault outcomes when a transient fault 710 appears during the time when CMD is asserted, due to (for example) a disturbance in another phase. Both the state-qualified circuit 100 (timing diagram 700A) and the blank-time-qualified circuit 200 (timing diagram 700B) generate a false fault indication OCF 705 and OCF′ 706, respectively, during the switching transient because neither the state qualifier element nor the blank time qualifier element transition during transient signal period 710. However, the debounce-qualified circuit 300 and the blank-time- and debounce-qualified circuit 400 prevent the false signal from propagating to FAULT because they requires the OCF′ signal to remain asserted for the debounce interval t_{DB} which does not occur due to the transient nature of the overcurrent indication by the OC signal.

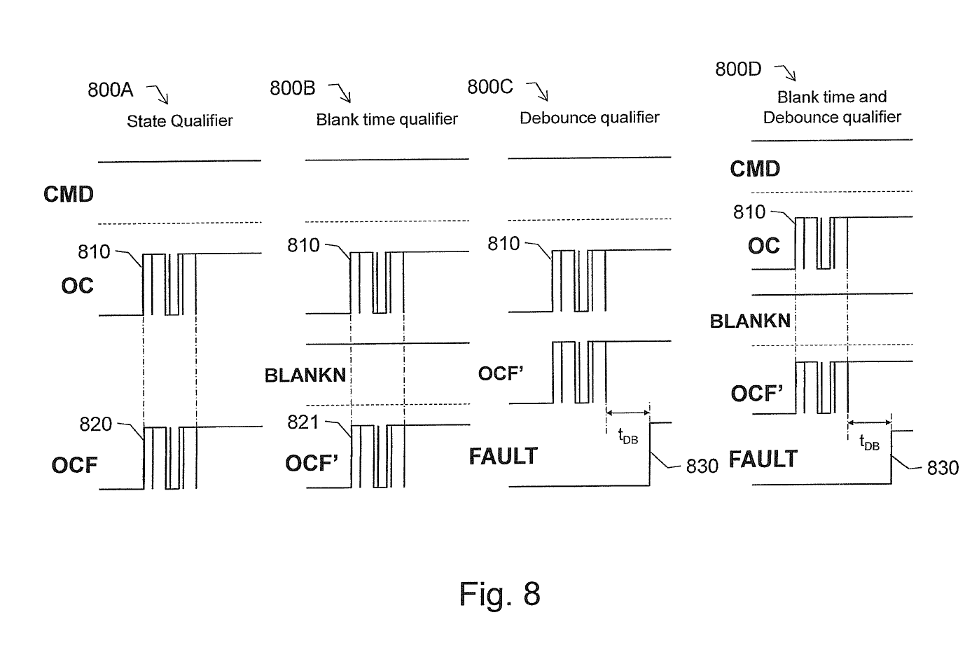

FIG. 8 shows the fault outcomes when a permanent fault 810 appears during the time CMD is asserted. In state-qualified circuit 100 and blank-time-qualified circuit 200, fault indications OCF 820 and OCF′ 821, respectively, appear as soon as OC transitions. However, in both the debounce-qualified circuit 300 and the blank-time- and debounce-qualified circuit 400, FAULT 830 does not assert until after debounce time interval t_{DB} lapses during which the OCF′ signal remains asserted, which illustrates the delay effect of the debounce timer on the speed of fault detection.

Further embodiments of the concepts, systems, and techniques may include a circuit or circuits implementing the above-noted functions, such as an integrated circuit, integrated semiconductor package, hybrid circuits, and/or systems consisting of a combination of hardware and software, all without limitation. Such variations, including implementations using software, firmware, microcode, or the like in whole or in part, or in combination with hardware, are all well-within the skill of one of ordinary skill in the art. Accordingly, the present circuits and systems are not limited to any particular form or platform. As one example, the driver circuit 320 and the overcurrent detectors 300 and 400 of FIGS. 3 and 4 may be provided in the form of a single integrated circuit.

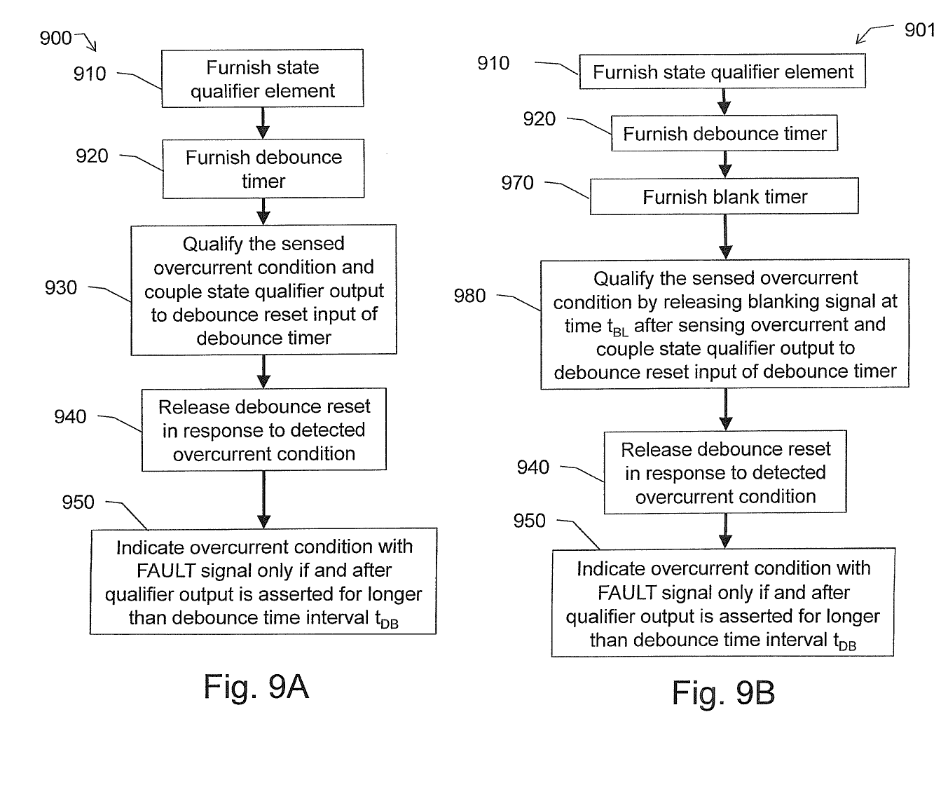

FIG. 9A is a flowchart of a method 900 of providing debounce-qualified overcurrent fault detection, according to one embodiment of the present invention. Starting with a state qualifier element, step 910, and a debounce timer in a circuit adapted to sense an overcurrent condition in a driven device, step 920, the method, in operation, qualifies the sensed overcurrent condition and couples the output of a state qualifier element (such as 350 in FIG. 3) to a debounce reset input of the debounce timer, step 930. The state qualifier releases, in one exemplary embodiment, the debounce reset signal in response to the detected overcurrent condition, step 940. The debounce timer indicates an overcurrent fault condition, step 950, by asserting the overcurrent fault signal FAULT only if and after the qualifier output is asserted for longer than the debounce time interval t_{DB}.

FIG. 9B is a flowchart of an alternate method 901 of providing debounce-qualified overcurrent fault detection, according to another embodiment of the present invention. Starting again with a state qualifier and a debounce timer in step 910 and 920, the method next furnishes a blank time qualifier in step 970. In operation, the method qualifies the sensed overcurrent condition by releasing (in one exemplary embodiment) the blanking signal at time t_{BL} after sensing an overcurrent condition and couples the output of the state qualifier element (such as 450 in FIG. 4) to the debounce reset input of the debounce timer, step 980. The state qualifier releases, in one exemplary embodiment, the debounce reset signal in response to the detected overcurrent condition, step 940. The debounce timer indicates an overcurrent fault condition, step 950, by asserting the overcurrent fault signal FAULT only if and after the qualifier output is asserted for longer than the debounce time interval t_{DB}.

The order in which the steps of the present method are performed is purely illustrative in nature. In fact, the steps can be performed in any order or in parallel, unless otherwise indicated by the present disclosure.

The method of the present invention may be performed in either hardware, software, or any combination thereof, as those terms are currently known in the art. In particular, the present method may be carried out by any combination of hardware, non-transitory software, firmware, and/or microcode operating on or stored in a computer or computers of any type. Additionally, software embodying the present invention may comprise computer instructions in any form (e.g., source code, object code, and/or interpreted code, etc.) stored in any non-transitory computer-readable medium (e.g., ROM, RAM, magnetic media, punched tape or card, compact disc [CD], digital versatile disc [DVD], solid stated disk [SSD]), and/or the like, without limitation). Furthermore, such software may also be in the form of a computer data signal embodied in a carrier wave, such as that representing the well-known Web pages transferred among devices connected to and within a computer network, such as but not limited to the Internet. Accordingly, the present invention is not limited to any particular platform, unless specifically stated otherwise in the present disclosure.

While particular embodiments of the present invention have been shown and described, it will be apparent to those skilled in the art that various changes and modifications in form and details may be made therein without departing from the spirit and scope of the invention as defined by the following claims. For example, it will be appreciated by those of ordinary skill in the art that references to signals being asserted corresponding to a particular signal direction transition (e.g., low to high) and active high or low inputs to a device can be readily varied without departing from the spirit of the invention. Accordingly, the appended claims encompass within their scope all such changes and modifications.

1. A method of qualifying an overcurrent fault signal, comprising:
furnishing a state qualifier element responsive to a state input and responsive to an overcurrent input generated by sensing an overcurrent condition, said state qualifier element having a qualifier output, said state qualifier element configured to assert said qualifier output when said state input and said overcurrent input are mutually asserted;
furnishing a debounce timer having a debounce reset input and an overcurrent fault signal output;
coupling the qualifier output to the debounce reset input; and
causing said overcurrent fault signal to transition to indicate said overcurrent condition at a predetermined time after said debounce reset input transitions to an asserted state if the qualifier output remains asserted during said predetermined time.

2. The method of claim 1, further comprising:
furnishing a blank timer having a blanking reset input responsive to said state input and a blanking signal output operably coupled to said qualifier element;
wherein said blank timer delays said blanking signal output for a second predetermined time after said state input transitions to an asserted state.

3. The method of claim 1, wherein said predetermined time ranges from approximately 1 nanosecond to 100 milliseconds.

4. The method of claim 2, wherein said second predetermined time ranges from approximately 1 nanosecond to 100 milliseconds.

5. The method of claim 1, further comprising:
furnishing a comparator coupled to a driven device and providing the overcurrent input indicative of a voltage across the driven device exceeding a threshold voltage.

6. The method of claim 1, wherein the state input is a signal indicative of a conduction state of a driven device.

7. A circuit adapted to sense and signal an overcurrent fault, comprising:
a state qualifier element responsive to a state input and responsive to an overcurrent input, and having a qualifier output, said state qualifier element configured to assert said qualifier output when said state input and said overcurrent input are mutually asserted; and
a debounce timer having a debounce reset input and a overcurrent fault signal output, said debounce reset input operably coupled to said qualifier output,
wherein said debounce timer causes said overcurrent fault signal to transition to indicate an overcurrent condition at a predetermined time after said debounce reset input transitions to an asserted state if the qualifier output remains asserted during said predetermined time.

8. The circuit of claim 7, further comprising:
a blank timer having a blanking reset input responsive to said state input and a blanking signal output operably coupled to said state qualifier element,
wherein said blank timer delays said blanking signal output for a second predetermined time after said state input transitions to an asserted state.

9. The circuit of claim 7, wherein said predetermined time ranges from approximately 1 nanosecond to 100 milliseconds.

10. The circuit of claim 8, wherein said second predetermined time ranges from approximately 1 nanosecond to 100 milliseconds.

11. The circuit of claim 7, further comprising a comparator coupled to a driven device and providing the overcurrent input indicative of a voltage across the driven device exceeding a threshold voltage.

12. The circuit of claim 7, wherein the state input is a signal indicative of a conduction state of a driven device.

13. An apparatus for qualifying an overcurrent fault signal, comprising:
means for furnishing a state qualifier element responsive to a state input and responsive to an overcurrent input generated by sensing an overcurrent condition, said state qualifier element having a qualifier output, said state qualifier element configured to assert said qualifier output when said state input and said overcurrent input are mutually asserted;
means for furnishing a debounce timer having a debounce reset input and an overcurrent fault signal output;
means for coupling the qualifier output to the debounce reset input; and
means for causing said overcurrent fault signal to transition to indicate said overcurrent condition at a predetermined time after said debounce reset input transitions to an asserted state if the qualifier output remains asserted during said predetermined time.

14. The apparatus of claim 13, further comprising:
means for furnishing a blank timer having a blanking reset input responsive to said state input and a blanking signal output operably coupled to said qualifier element;
wherein said blank timer delays said blanking signal output for a second predetermined time after said state input transitions to an asserted state.
